(19) United States
(12) Patent Application Publication
(10) Pub. No.: US 2011/0114573 A1
(43) Pub. Date: May 19, 2011

(54) Devices and Methods for Removing Contaminants and Other Elements, Compounds, and Species from Fluids

(76) Inventors: Robert C. Simpson, Fenton, MI (US); Victor I. Petrik, Leningrad Oblast (RU)

(21) Appl. No.: 12/871,545

(22) Filed: Aug. 30, 2010

Related U.S. Application Data
(60) Provisional application No. 61/237,883, filed on Aug. 28, 2009.

(51) Int. Cl. B01D 39/06; B01D 29/00; B01D 37/00; B82Y 30/00

(52) U.S. Cl. 210/807; 210/287; 210/490; 210/506; 210/457; 210/504; 210/507; 210/508; 977/902

(57) ABSTRACT

Embodiments of the present invention provide filtration media that includes graphene powder, compositions including the media, filtration devices for use with the media, and methods for using the filtration media and compositions to remove unwanted contaminants and/or other elements, compounds, and species from fluids.

### CROSS-REFERENCE TO RELATED APPLICATION

This application claims the benefit of U.S. Provisional patent application Ser. No. 61/237,883, filed Aug. 28, 2009, which is incorporated herein by this reference in its entirety.

### FIELD

Embodiments of the present invention relate to devices and methods for removing contaminants and/or other elements, compounds, and species from fluids.

### BACKGROUND

A variety of contaminants such as toxins, bacteria, cysts, volatile organic compounds (VOC's), noxious fumes, and other chemical agents may be present in fluid streams such as air and water. It is often desirable or necessary to remove these contaminants.

There are numerous methods for removing contaminants from fluids. These methods include membrane filtration, solvent-based processes, air stripping, and adsorption onto a solid; however, all of these methods suffer from one or more disadvantages. Manufacture of membranes for filtration is relatively complex, so membrane filtration is not an economically attractive solution. Solvent-based processes have associated high energy costs, so they are also not economically attractive. Air stripping is relatively simple, but the liberated contaminant must still be captured and destroyed, which is often problematic. Finally, solid adsorbents, such as powdered or granular activated carbon (“GAC”), are generally inexpensive, simple to use, and provide relatively high flow rates; however, many contaminants adsorb poorly to activated charcoal.

Therefore, while various materials and methods for removal of one or more contaminants are known in the art, all of them suffer from disadvantages. Thus, there is still a need to provide improved materials and methods to remove contaminants from a fluid.

### SUMMARY

The present invention is directed to graphene powders, use of graphene powders as at least one component of filtration and adsorption media, and filtration apparatus that include filtration media including graphene powders.

In some embodiments, graphene powders of the present invention are chemically modified, i.e. doped, derivatized, impregnated, coated (in whole or in part) or otherwise attached to or associated with one or more chemical compounds and/or metals. In some embodiments of the present invention, the graphene powders may be coupled to a solid phase and/or the powders may be enclosed in a housing at least a portion of which is permeable to a fluid. The graphene powders described herein, in some embodiments, are capable of interacting with a wide variety of contaminants and/or other elements, compounds, and species including but not limited to toxins, certain biological agents, certain metals, volatile organic compounds (VOC's), tobacco fumes and smoke, combustion gases, chemical warfare agents, harmful vapors and noxious fumes.

Accordingly, some embodiments of the present invention provide filtration media that include at least one graphene powder that is either chemically modified or unmodified. These filtration media may, but do not necessarily, include additional graphene powders and/or other components such granular activated carbon, titanium oxide, or diatomaceous earth.

Other embodiments of the present invention provide compositions that include a substrate having a filtration media applied to or associated with the substrate. The substrate may be, but is not limited to, a polymer, a metal or metal alloy, a textile fiber, a glass or ceramic material, a sol-gel, or any combination thereof. Various fibrillated fibers such as polypropylene, Kevlar®, Twaron® and certain other fibers can be used with or without resins. In some embodiments the substrate is a yarn, thread, fiber, woven or non-woven fabric. The filtration media may include one or more graphene powders and/or other components consistent with the present invention. The filtration media may be applied to or associated with the substrate, for example through adsorption, absorption, as an impregnate, or as a coating.

Still other embodiments of the present invention provide filtration apparatus that include a containment device, such as a housing or cartridge, that is permeable to a fluid and at least one filtration media disposed within the housing. The filtration media may include one or more graphene powders and/or other components consistent with the present invention and those components may be disposed within the housing as a homogeneous mixture, as individual components in discrete predetermined locations, as a media applied to or associated with a substrate that is itself disposed within the housing, or any combination thereof.

In some embodiments, a filtration apparatus of the present invention includes a support structure with a filtration media applied thereto and/or a support structure in contact with a composition that includes a substrate and a filtration media. In some embodiments, the support structure is permeable to a fluid. In some embodiments a fluid may flow through the permeable device and also through the substrate and filtration media. The substrate may be, but is not necessarily, a yarn, thread, fiber, woven, or non-woven fabric and the filtration media may include one or more graphene powders and/or other components consistent with the present invention. In other embodiments, the filtration media may be applied to or associated with the support structure itself and the apparatus may or may not include an additional substrate and filtration media. The filtration device may be configured for any type of fluid flow, including but not limited to, axial flow, radial flow, and any combination thereof. The substrate may or may not be compressed and may be held together with a suitable porous material or by some other mechanical means.

### BRIEF DESCRIPTION OF THE DRAWINGS

FIG. 1 is a side view of a filtration apparatus suitable for use with the filtration media described herein.

FIG. 2 is a side view of a filtration apparatus suitable for use with the filtration media described herein.

FIG. 3 is a side view of a filtration apparatus suitable for use with the filtration media described herein with a cutaway showing the inside of the filtration apparatus filled with a first media according to the present invention.

FIG. 4 is a side view of a filtration apparatus suitable for use with the filtration media described herein with a cutaway showing the inside of the filtration apparatus filled with a second media according to the present invention.

FIG. 5 is a side view of a filtration apparatus suitable for use with the filtration media described herein with a cutaway showing the inside of the filtration apparatus filled with a third media according to the present invention.

FIG. 6 is a side view of a filtration apparatus suitable for use with the filtration media described herein with a cutaway showing the inside of the filtration apparatus filled with a fourth media according to the present invention.

FIG. 7A is a side view of a filtration device suitable for use with the filtration media described herein.

FIG. 7B is an end view of the filtration device illustrated in FIG. 7A.

FIG. 7C is a side view of a portion of the filtration device illustrated in FIG. 7A.

FIG. 7D is a perspective view of the filtration device illustrated in FIG. 7A.

FIG. 8A is a perspective view of a filtration device suitable for use with the filtration media described herein.

FIG. 8B is a top view of the filtration device illustrated in FIG. 8A.

FIG. 9 is a top view of a filtration device suitable for use with the filtration media described herein.

### DETAILED DESCRIPTION

Described herein are filtration and adsorption media containing graphene powders, compositions that include a filtration media applied to or associated with a substrate, and filtration devices for use with filtration media. The graphenes can be unmodified or doped, and can optionally be combined with a substrate and/or resin.

In one aspect, the invention provides a novel filtration media for removing contaminants and/or other elements, compounds, and species from a fluid. In some embodiments, the filtration media of the present invention includes at least one graphene powder that is either chemically modified or unmodified. The filtration media may, but do not necessarily, include additional graphene powders and/or other components such as granular activated carbon, titanium oxide, or diatomaceous earth.

Turning now to the individual components of the filtration media, the media includes graphene powders. In some embodiments, graphene powders include graphene molecules that may include single or layered sheets of graphene, which in some embodiments is a substantially planar sheet of sp²-bonded carbon atoms. In various embodiments, graphene sheets may have various configurations, and the particular configuration will depend on (among other things) the amount and position of five-membered and/or seven-membered carbon rings in the sheet. The graphenes may be fully or partially exfoliated. A fully exfoliated graphene can be visualized as a sheet of pulp paper that has been sliced into 1-atom thick individual sheets. A partially exfoliated graphene can be visualized as that same sheet of pulp paper in which certain individual sheets are randomly more than one atom thick in some locations—when these individual sheets are stacked together they would be substantially thicker than those depicted for a fully exfoliated graphene.

In some embodiments the graphene powders also include molecules in which several (e.g., one to one hundred) single layers of graphene sheets are stacked on top of each other to a maximum thickness of less than about 100 nanometers. Consequently, graphene in some embodiments may be a single layer of aromatic polycyclic carbon and in other embodiments may be a plurality of such layers having a thickness of less than about 100 nanometers.

In some embodiments the graphenes of the present invention are significantly distinct in structural and molecular aspects from currently known expanded graphite/intercalated graphite. For example, the specific gravity of graphite is approximately 2.2. Graphenes of the present invention have specific gravities (i.e., relative weight per unit volume) significantly below those of graphite and expanded graphite. As an example, in some embodiments, partially exfoliated graphenes have specific gravities in the range of about 0.01 to about 0.005. Fully exfoliated graphenes could have a specific gravity of less than about 0.005 to about 0.0001 if not fully compressed. The specific gravity of expanded graphite depends on its degree of expansion, but is between that of graphite and graphene because its partial separation makes it less dense than graphite, but more dense than the fully separated graphene sheets.

Among other differences, graphenes in some embodiments are substantially monoatomic (and in some cases oligoatomic) flat or wrinkled layers of polycyclic aromatic carbon, while expanded graphite typically has a worm-like configuration with wall thicknesses in the micrometer range. Expanded graphite typically consists of layers of graphene that are covalently bonded together (typically about 2-50 layers), but are not fully separated, individual sheets. Expanded graphite is only partially exfoliated with minimal separation of the van der Waals bond. The expanded graphite would be much more dense that graphenes if two samples were compared with similar compression. By way of example, 1 cc of expanded graphite might weigh 0.2 grams where one 1 cc of fully exfoliated graphene might weigh only 0.005 grams.

Moreover, the interconnected thick walls of expanded graphite in the worm-like configurations resemble a wadded up or tangled sheet structure, whereas the monoatomic (and in some cases oligoatomic) flat or wrinkled graphene layers in some embodiments of the present invention are independent sheets. The graphene can have a surface area of from about 75 m²-2500 m², depending on the degree of exfoliation and other factors.

Single sheets of graphene, as in some embodiments of the present invention, can act as individual filters allowing each sheet to exhibit maximum effectiveness. A wadded up or tangled sheet configuration, such as is typical in expanded graphenes, is less efficient as a filter because once the sheets on the surface interact with contaminant or other element to be filtered, the openings in the surface sheets and/or reactive sites on the surface sheets become plugged or blocked such that a fluid cannot flow through the structure and is forced to flow around the structure. Thus the fluid and the contaminants or other elements therein cannot contact the expanded graphite in the internal portion of the wadded up or tangled structure and the internal graphite layers are ineffective for filtration.

In some embodiments the graphene powders may also include graphene nanostructures including, but not limited to, nanotubes, nanofractals, fractals and other fullerenes. In some embodiments the nanotubes are open on both ends. While the graphenes of the present invention may include these additional nanostructures in some embodiments, these other nanostructures can be less effective than graphenes for filtration for the same reasons that the wadded up and/or tangled sheets of expanded graphite discussed above are less effective than individual graphene sheets.

In some embodiments the graphenes of the present invention may be chemically modified by being doped or derivatized with one or more heteroatoms and/or functional groups. Derivatized and/or substituted refers to a replacement of a chemical group or substituent with a heteroatom or a functional group. This chemical modification may be the result of forming graphenes from doped or derivatized starting materials or of chemical modification of the graphene after it is formed. For example, after a graphene is formed, it may be further derivatized by chemical compounds (e.g., fluorination, oxidation, amidation, etc.) to introduce pendant (within the graphene plane) or terminal (at the end of a graphene) functional groups or dopants.

In other embodiments, graphenes may be chemically modified by being impregnated, coated (in whole or in part) or otherwise attached to or associated with one or more chemical compounds and/or metals. In some embodiments the coating of the metal on the nanostructure is relatively thin. For example, in some embodiments suitable coatings have a thickness of less than 100 atoms, less than 50 atoms, less than 10 atoms, or less than 5 atoms.

In some embodiments, graphenes suitable for use in the present invention are produced by the methods described in U.S. Patent Application Publication No. 2006/0121279, filed Dec. 7, 2004, the disclosure of which is hereby incorporated by reference in its entirety. If desirable, the graphenes produced by these methods may also be subjected to further processing. In some embodiments, graphenes may be subjected to reintroduction of fluid and further expansion. These graphenes may also be subjected to physical treatments such as compaction and/or heating, sonication, size separation, and similar processes.

The filtration media of the present invention may optionally include other components such as powdered or granular activated carbon; iodine pellets and/or nanoiodine pressed into pellets; titanium oxide; diatomaceous earth; and other chemicals, powders, and metals, particularly noble metals, known to generate particular performance characteristics for filtration. The particular application for which the media is used will determine whether and in what amount it is desirable to include other components. For example the other components may be blended in the media to enhance filtration absorption. In embodiments including granular activated carbon (GAC), the GAC may be used to enhance the rigidity of a cartridge casing. In some embodiments, a filter cartridge is sufficiently rigid so that GAC is not required and/or the amount of GAC is minimized. In other embodiments no GAC is used. As further explained below, the graphenes are combined with various substrates and/or resins.

Turning now to the composition of the filtration media, in some embodiments, the filtration media of the present invention may include one or more of following: undoped graphene powder (Graphene-P), graphene powder that has been chemically modified with silver (Graphene-Ag), iodine (Graphene-I), manganese (Graphene-Mn), iron (Graphene-Fe), platinum (Graphene-Pt), gold (Graphene-Au) and/or other metals and/or additives. In some embodiments, filtration media includes one or more graphene powders selected from Graphene-P, Graphene-Ag, and Graphene-I.

In other embodiments, filtration media includes at least one graphene powder as described above and at least one other component, such as GAC, Twaron®, resin or other components as described above. Without intending to be bound by the mechanisms further described, it is believed that the pores in the graphenes mechanically filter and also absorb the contaminants. It is further believed that the dopants enhance this process.

In some embodiments, a graphene filtration media may be formulated as an arsenic sorbent (i.e., a filtration media configured to remove arsenic from a contaminated fluid). Any of the graphenes described herein may be incorporated into the arsenic sorbent. In one embodiment, the arsenic sorbent includes Graphene-P, Graphene-Ag and Graphene-I.

In various embodiments the media components may be present in various ratios according to the filtration requirements for a particular application. For example the filtration media may include, as an arsenic sorbent, Graphene-P, Graphene-Ag and Graphene-I. In one embodiment a filtration media includes 20 to 100% by weight Graphene-P with the balance being 0-80% by weight Graphene-Ag and 0-80% by weight Graphene-I. The filtration media may include 0-95% by weight of this arsenic sorbent, with the balance being a substrate having one or more of the substrate materials described herein. In another embodiment a filtration media includes 0-95% by weight of an arsenic sorbent having 20-100% by weight Graphene-Ag with the balance being 0-80% by weight Graphene-P and 0-80% by weight Graphene-I. In still another embodiment a filtration media includes up to 100% by weight arsenic sorbent. Typically, but not always, the amounts of Graphene-I and Graphene-Ag do not exceed 50% by weight combined.

In another embodiment, the filtration media may include from 0-95% by weight arsenic sorbent having from about 2% to about 50% by weight Graphene-Mn, from about 2% to about 50% by weight Graphene-Fe and from about 2% to about 50% by weight Graphene-Ag. The balance of the filtration media is a substrate including one or more of the substrate materials described herein.

Turning now to the use of the filtration media described herein, contaminants and/or other elements, compounds, and species may be present in a gaseous medium and/or in a liquid medium, and it is generally contemplated that all manners of contacting the contaminants and/or other elements, compounds and species with contemplated compositions are suitable to remove at least a portion of the contaminant and/or other elements, compounds, and species from the medium. For example, where the contaminant is disposed in a liquid medium, contemplated compositions may be admixed to the medium. Similarly, the composition may be injected into a gas stream containing the contaminant and may then be removed (e.g., via precipitator or filter) once the contaminant has bound to the composition.

In other embodiments, the filtration media described herein may be used with a support structure or a housing. For example, in some embodiments the composition may be disposed in a container that allows passage of at least some of the contaminant through the container such that it comes into contact with the composition.

While not wishing to be bound to any specific mechanism or theory, it is believed that the filtration media described herein interacts with contaminants and/or other elements, compositions, and species primarily through non-covalent interactions. For example, in some embodiments, the filtration media described herein interacts with contaminants and other elements chemically, such as through ionic interactions, dipole-dipole interactions, or van der Waals interactions. In some embodiments, it is believed that the filtration media described herein interacts with contaminants and other elements physically, such as by preventing the contaminant or other element from passing through the molecular lattice of a graphene sheet and/or trapping that contaminant or other element within the graphene lattice.

When the contaminant is non-covalently bound to the composition, in some embodiments the filtration media can be regenerated in a relatively simple manner. Among other options, in some embodiments a large proportion (typically >70%) of the contaminant can be removed from the composition by centrifugal or compressive force, wherein the particular force will at least to some degree cause the release of the contaminant. Alternatively, where possible, the contaminant can be thermally removed (e.g. sublimated or combusted) from the composition using temperatures of up to 3500° C. Further aspects, compositions, methods, and uses are disclosed in U.S. Patent Application Publication No. 2006/0121279, filed Dec. 7, 2004 and U.S. Patent Application Publication No. 2006/0120944, filed Dec. 7, 2004, the disclosures of which are hereby incorporated by reference in there entireties.

In another aspect the invention provides compositions that include a filtration media applied to or associated with a substrate. In some embodiments, application of a media to a substrate includes attachment or association at least through adsorption, absorption, impregnation, coating (including partial coating), or other reasonable means.

Turning now to the individual components of the composition, in some embodiments suitable substrates include natural and synthetic polymers, metals and metal alloys, textile fibers, glass and ceramic materials, sol-gels, and combinations thereof. In some embodiments polymeric substrates include fibrillated or non-fibrillated fibers formed from, e.g., polypropylene, polyethylene, aramids such as Kevlar® or Twaron®, nylon, or combinations thereof. In some embodiments the substrates are threads, yarns, fibers, woven or non-woven fabrics, or combinations thereof. In some embodiments the substrate is a spun-bonded polypropylene. In other embodiments, the substrate is a foam, such as a polymeric or metal foam. In some embodiments the foam is a polypropylene foam. In other embodiments the foam is a metal foam or is a “tangle” or “wool” of metal alloy fibers or filaments such as, for example, a plurality of strands of very fine metal filaments similar to steel wool. The metal foam may include metals such as, but not limited to, brass-based alloys, titanium-based alloys, steel-based alloys, and aluminum-based alloys. The foam may have an open-cell, closed-cell or reticulated structure. In one embodiment, the foam is open-cell foam.

In some embodiments the substrate is at least in part permeable to a fluid, or shaped into a form (e.g. a fabric, filter, porous solid, etc.) that is permeable to a fluid In some embodiments the substrate may be a textile, a polymeric or metal foam, a porous solid, or another permeable substrate. In some embodiments the porosity or permeability of the substrate may provide secondary filtration in addition to the filtration provide by the filtration media.

Turning now to the media applied to or associated with the substrate, in some embodiments, the media is any filtration media described herein or any filtration media not inconsistent with the present disclosure. In some embodiments, the media may be added to the substrate in an amount of from about 0.1% to about 80% by weight. By way of example, but not limitation, the application of media to a fabric, yarn, thread, fiber, or other substrate can be achieved by heating the host substrate to a point where the filtration media at least partially melts into the host substrate. These media-treated substrates can be used as filtration devices or with filtration devices. Yarn or thread treated with a filtration media described herein may be used alone or with other treated or untreated yarns or threads to weave fabrics.

In one embodiment, the media includes one part by weight of resin, Twaron® or another substrate and one part by weight graphenes (plain and/or doped). One part by weight GAC powder may optionally be added to the media. The amount of each of these components relative to the others can be varied from about 0.2:1 to 5:1 (i.e., the amount of each constituent relative to the others can be reduced by 80% or increased by 500%) based on the type of contaminants to be filtered and the desired filtration results.

In certain embodiments, resins may be used to cause or help graphene to adhere to various substrates, threads, yarns, fabrics, etc. Suitable thermosetting resins include, but are not limited to, epoxy, polyester, vinyl ester, phenolic, polyurea, polysiloxane, acrylic, thermosetting elastomers (ethylene propylene diene Monomer (EPDM) as an example) and polyurethane. Suitable thermoplastic resins include, but are not limited to, polyethylene, polypropylene, thermoplastic urethane (TPU), ethylene copolymers and terpolymers (ethylene vinyl acetate and ethylene methyl acrylate as examples), acrylonitrile butadiene styrene (ABS), polyamide, polystyrene, polyacrylate, polycaprolactone, polyethylene terepthalate, polybutylene terepthalate, fluoropolymer (polytetrafluoroethylene as an example), polycarbonate, polyester, polyetheretherketone, polyetherimide, polyimide, polyphenylene oxide, polysulfone, polyether sulfone, polyvinyl chloride, polyvinylidene chloride, and phenoxy. The resin may formulated in advance to impart specific physical properties, such as desired flow characteristics, fusion characteristics, or cure activity. A typical process condition would be to expose the structure to an elevated temperature of 350° (F.) for 10-120 minutes to induce curing in a thermosetting resin or fusion in a thermoplastic resin.

The graphene media composition can be prepared as a wet or dry composition. For a wet mixture, the media composition, including the graphene and substrate/resin/etc. is mixed with a liquid. Any liquid that evaporates with minimal residue can be used. Water and ethyl alcohol are suitable liquids due to their low cost and low toxicity, although others could certainly be used to optimize process conditions. Alternatively, the resin could be solvated in a liquid with the solvating liquid then driven off during the heating process. This differs from the wet process in that in the wet process the resin remains as a discrete particle rather than being solvated in the resin.

Turning now to the use of the compositions, in some embodiments the substrate may be placed in contact with a fluid to allow the filtration media to contact contaminants and/or other elements, compounds, and species in the fluid. In some embodiments the substrate is sufficiently permeable to allow the fluid to flow through the substrate. In some embodiments the substrate may be used in conjunction with a filtration device, for example the substrate may be disposed within or supported by the filtration apparatus. In some embodiments, the compositions are fabrics with a filtration media absorbed to, adsorbed to, impregnated into, or coated onto the fabric. The fabric may act as a sorbent, filter component, anti-fungal and/or anti-microbial product. In some embodiments these fabrics may be used for filtration; clothing; blankets; canvas; tents; bedding, including but not limited to sheets, pillow cases and, in particular, hospital bedding; and other fabric coverings.

In another aspect, the invention provides filtration apparatus that include a containment device and/or a support structure and at least one filtration media disposed within the containment device, in contact with the support structure, and/or applied to or associated with a substrate that is supported by the support structure.

Turning now to the components of the filtration apparatus, in some embodiments the filtration apparatus includes a containment device. In some embodiments the containment device is a housing, cartridge, or similar device that may be partially or entirely filled with filtration media as described herein. In some embodiments, at least a portion of the containment device is permeable to a fluid and/or contains an inlet and an outlet such that a fluid may flow through the device and may contact the filtration media disposed therein.

In some embodiments the devices, in addition to housing the media, may include functional features that facilitate filtration. Devices that house the media of the present invention, in some embodiments, may also be designed to minimize tunneling and walling. Tunneling and walling lead to voids, known as worm holes, in the media that can substantially reduce the effectiveness of the filter. To reduce or prevent tunneling and walling, in some embodiments the devices may include ridges, and/or the inside walls of the cartridge casing may be abraded. In some embodiments where the device includes ridges, the device includes from about 1 to about 500 ridges per 10 inches of device. In some embodiments tunneling and walling may be reduced by compressing the media by about 0.25× to about 5× (i.e., by about 25% to about 500%).

In other embodiments, a filtration device of the present invention includes a support structure in contact with a filtration media and/or in contact with a composition that includes a filtration media applied to or associated with a substrate.

In some embodiments, the support structure may be a structure within a housing as described above. In other embodiments, the support structure may be independent of a housing or other containment device. In some embodiments, the support structure is porous or otherwise permeable to a fluid. In some embodiments a filtration media is applied to or associated with the support structure, such as by adsorption, absorption, coating, or impregnating. In other embodiments, the support structure is in contact with a composition including a filtration media applied to or associated with a substrate as described in detail above. In some embodiments, the support structure is configured such that the substrate may be wrapped around the support structure, laminated on a surface of the support structure in one or more layers, and/or sandwiched between two surfaces of one or more support structures. In some embodiments, the filtration apparatus is configured such that a fluid may flow through a fluid-permeable support structure and through a substrate/filtration media composition that is in contact with that support structure. The porosity or permeability of the support structure may, but does not necessarily, provide secondary filtration in addition to the filtration provided by the filtration media.

The media described above may be configured for use in a in a filter such as a multistage filter, axial flow filter or radial flow filter. Depending on the degree of exfoliation and the amount of compression of the media, graphene-based filtration media according to the present invention can have as many as 2×10¹² pores/mm².

In some embodiments, the media is disposed within a housing or other device, for example as bulk filtration media and/or as media applied to or associated with a substrate as described previously.

Components of any filtration media described herein or consistent with the present disclosure may be disposed within a filtration housing or device in a variety of configurations. For example, in some embodiments the media may be blended such that the composition is substantially homogeneous (i.e., the various media components are substantially equally distributed). Alternatively, in some embodiments the various media components may be disposed in discrete and predetermined regions, for example, stratified. In still other embodiments, the media may be adsorbed to, absorbed to, coated onto, or impregnated into a substrate as described in detail above, and the substrate/filtration media composition may be disposed within the housing or other device. In some embodiments, the substrate may be selected from natural and synthetic polymers, metals and metal alloys, textile fibers, glass and ceramic materials, sol-gels, and combinations thereof. In some embodiments, the substrate is a fabric, yarn, thread, or fiber. The configuration of the various media components will vary for different applications and may include a combination of configurations described above.

In other embodiments, a filtration media is applied to or in contact with a support structure. The filtration media may be any filtration media described herein or consistent with the present disclosure. For example, in some embodiments the media may be adsorbed to, absorbed to, impregnated into, or coated onto the support structure. In other embodiments, the filtration media is associated with a substrate as described previously and the substrate/filtration media composition is in contact with a support structure. For example, in some embodiments the composition may be wrapped around the support structure, laminated on a surface of the support structure in one or more layers, and/or sandwiched between two surfaces of one or more support structures. The filtration media in the substrate/filtration media composition may be any filtration media described herein or consistent with the present disclosure.

Turning now to the use of the filtration apparatus, in some embodiments, a filtration apparatus described herein may be configured for any type of fluid flow, including but not limited to axial flow, radial flow, and any combination thereof. As an example, in some embodiments an axial flow filtration apparatus is configured to be placed within the flow path of a fluid with an inlet upstream where the fluid enters the device and an outlet downstream where the fluid leaves the device. Alternatively, in some embodiments, the filtration apparatus may be porous or permeable to the fluid such that a separate inlet and/or outlet is not necessary.

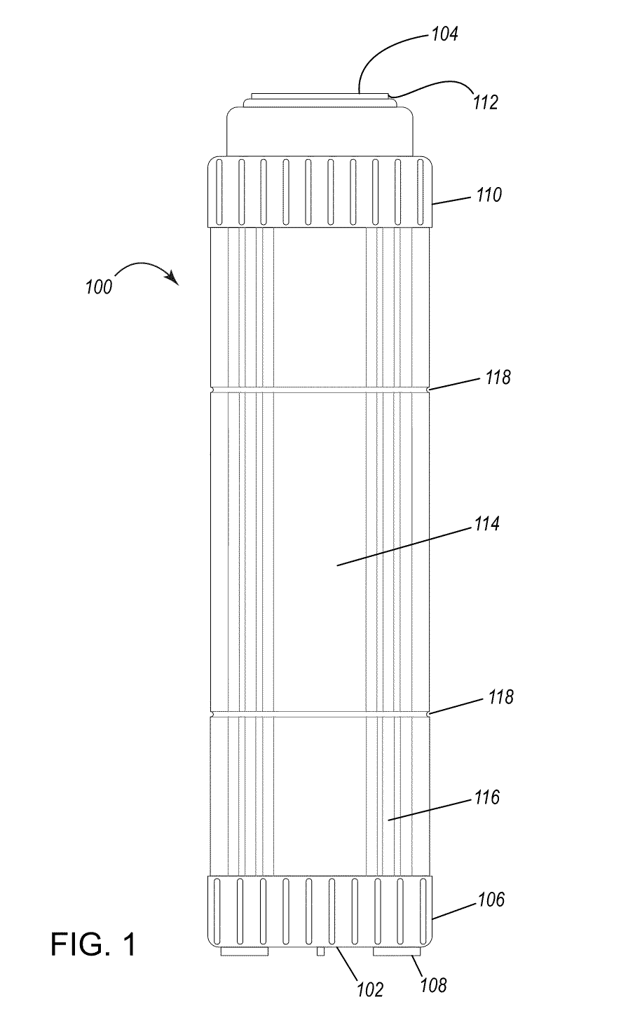

As an example, one embodiment of an axial flow apparatus is shown in FIG. 1. FIG. 1 depicts an example of a filter apparatus 100 suitable for use with the media described herein. The filter has an inlet 102 at a first end and an outlet 104 at a second end. The inlet 102 has a ribbed cap 106 with feet 108. The outlet 104 has a ribbed cap 110 and also has a washer 112 adjacent to the cap 110 and on the side of the cap 110 opposite the filter body 114. The filter body 114 has longitudinal raised ridges 116 extending from the inlet cap 106 to the outlet cap 110. The filter body 114 also has inverted ridges 118 extending around the perimeter of the filter body 114.

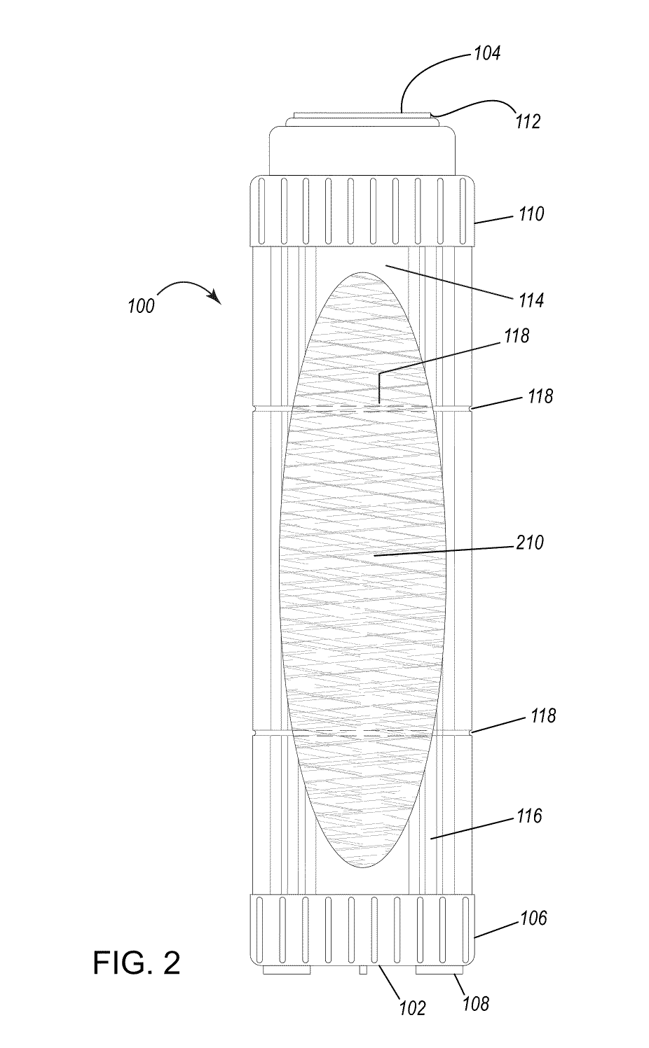

FIG. 2 depicts the filter apparatus 100 shown in FIG. 1 with a portion of the filter body 114 cut away to show abrasions 210 on the interior the filter body 114. The inverted ridges 118 on the outside of the filter cartridge 100 have a raised ridge when viewed from the interior of the filter apparatus 100.

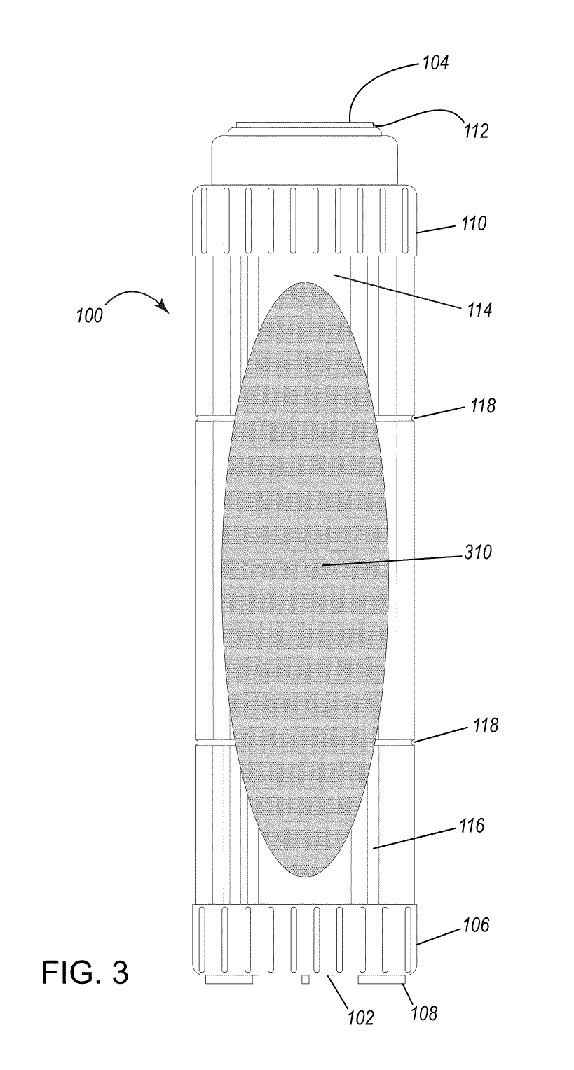

FIG. 3 depicts the filter apparatus 100 shown in FIG. 1 with a portion of the filter body 114 cut away to show a first media 310 disposed within the filter apparatus 100 wherein the first media 310 includes a homogeneous mixture of small granules of one or more graphene powders as described herein.

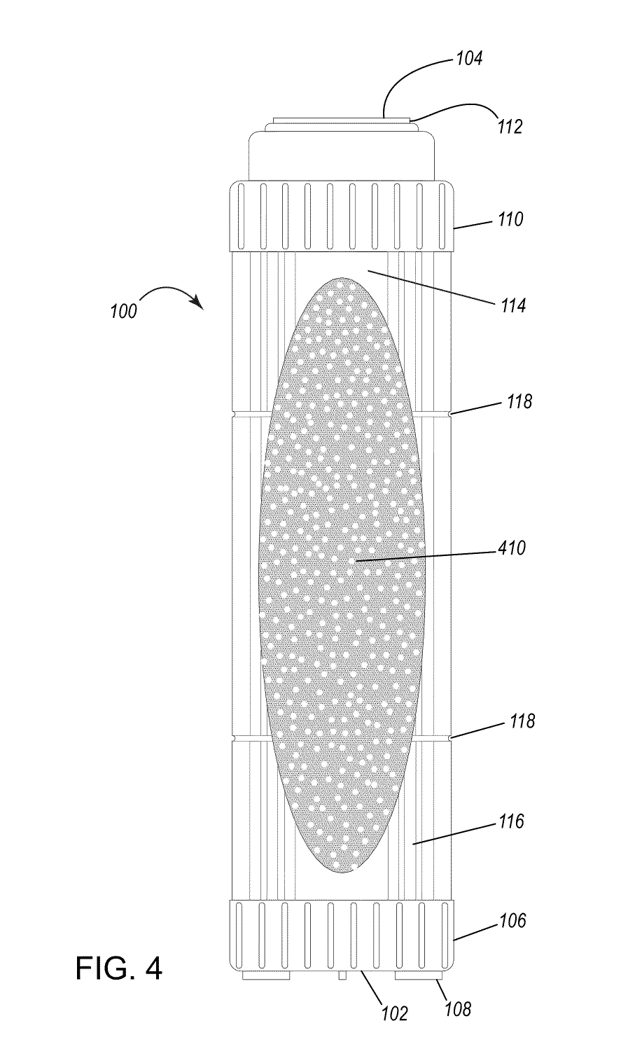

FIG. 4 depicts the filter apparatus 100 shown in FIG. 1 with a portion of the filter body 114 cut away to show a second media 410 disposed within the filter apparatus 100 wherein the second media 410 includes a homogeneous mixture of small granules of one or more graphene powders as described herein and at least one additional component as described herein, such as a granulated activated carbon.

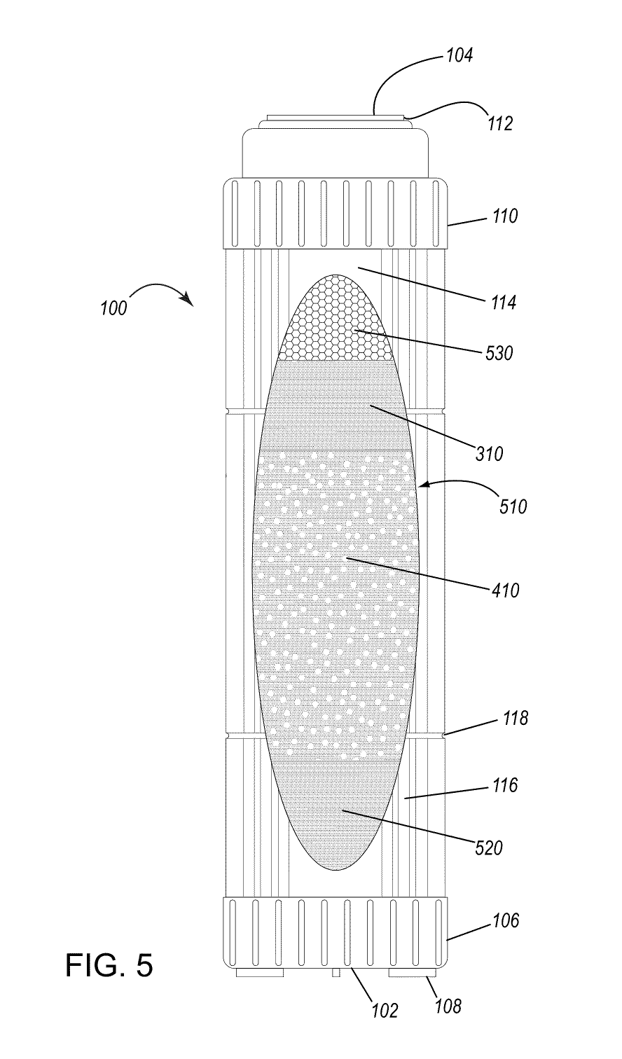

FIG. 5 depicts the filter apparatus 100 shown in FIG. 1 with a portion of the filter body 114 cut away to show a third media 510 disposed within the filter apparatus 100 wherein the third media 510 includes layers of various media components as described herein. For example, adjacent to the inlet is an arsenic sorbent 520. Adjacent to the 520 is the second media 410. Adjacent to the second media 410 is the first media 310. And, adjacent to the third media 310 is GAC 530.

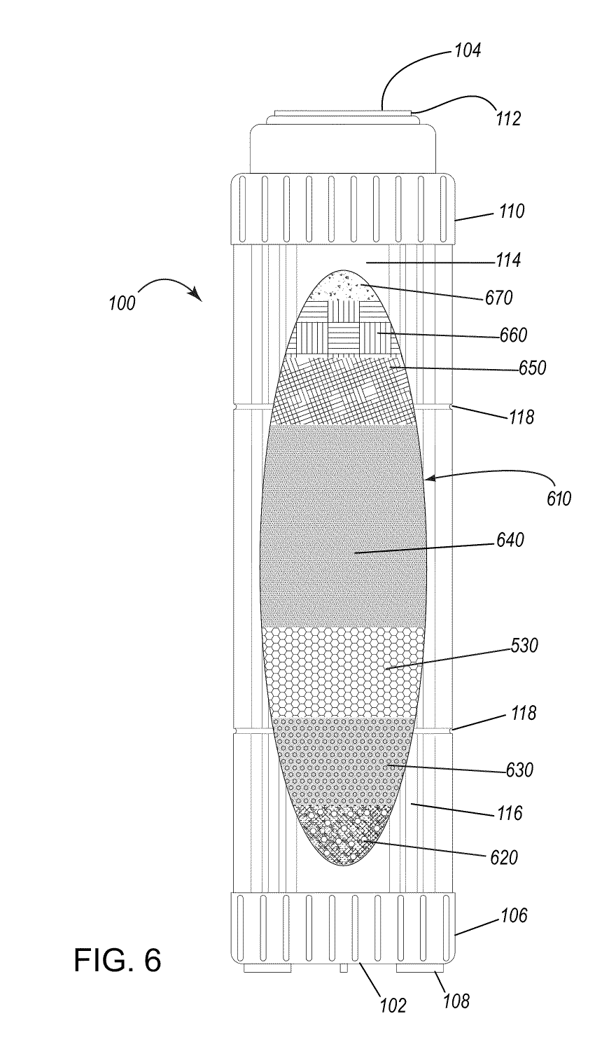

FIG. 6 depicts the filter apparatus 100 shown in FIG. 1 with a portion of the filter body 114 cut away to show a fourth media 610 disposed within the filter apparatus 100, wherein the fourth media 610 includes layers of various media components and substrates including media components as described herein. For example, adjacent to the inlet is a blend 620 of all of the components that make up the media in the apparatus 100. Adjacent to the blend 620 of all components is a mixture of other filtration media 630 including titanium oxide and diatomaceous earth. Adjacent to the other filtration media 630 is GAC 530. Adjacent to the GAC 530 is a homogeneous blend 640 including Graphene-P, Graphene-Ag, Graphene-I, and an arsenic sorbent. Adjacent to the homogeneous blend 640 is a brass-based alloy foam 650. The brass-based alloy foam 650 includes a plurality of strands of very fine brass-based alloy filaments. The brass foam may also be impregnated with the homogeneous blend 640. Adjacent to the brass-based alloy foam 650 is a fabric 660. The fabric includes spun-bonded polypropylene fibers (woven and randomly placed) that are impregnated with the homogeneous blend 640. Finally, adjacent to the fabric 660 is a foam 670. The foam may be polypropylene impregnated with the homogeneous blend 640.

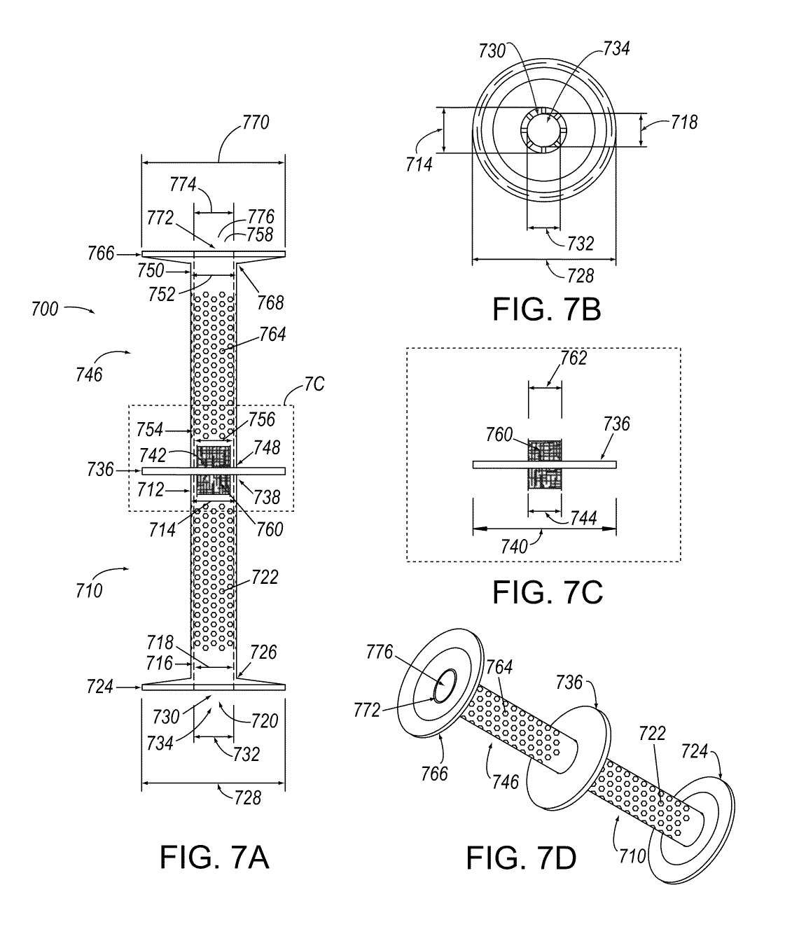

In other embodiments, a filtration apparatus described herein may be a radial flow device. As an example, in one embodiment a radial flow device may be a substantially cylindrical device configured to be placed in a flow path of a fluid such that the fluid flows through an inlet (or other fluid permeable portion of the device) into a central chamber along the axis of the device, and then flows from the central chamber outward radially through the device. In other embodiments, radial flow devices may be configured to allow a fluid to flow radially inward through the device into a central chamber along the axis of the device and then out of the central chamber through an outlet (or other fluid permeable portion of the device). In some embodiments a device may be configured to allow a combination of outward radial flow and inward radial flow, such as in sequence. FIGS. 7A-7D show an example of a two stage radial flow device suitable for use with the filtration media described herein.

A radial filter may be constructed in a variety of forms that range from, but are not limited to, a hollow center core beginning with a single stage core without any mesh, foam or other components. Cores are constructed as single stage, double stage, triple stage and more depending on the requirements associated with lowering contaminants of different types. Various types and compositions of mesh and or screen, fabrics, fibers and foams (materials) may be used to reduce contaminants in the effluent. The materials may be added between layers or stages and be layered in and of themselves-upon each other outside the core, inside the inner core or in multiple layers anywhere in the filter.

FIGS. 7A-7D show a filtration device 700 which has a first hollow cylindrical porous body 710 having an outer surface 712 defining an outer diameter 714 and an inner surface 716 defining an inner diameter 718 and a central void space 720. The first hollow cylindrical porous body 710 has a first plurality of pores 722 extending from the outer surface 712 to the inner surface 716 configured to allow a fluid to flow between the central void space 720 and the outer surface 712.

The filtration device 700 has a first flange 724 adjacent to a first end 726 of the first hollow cylindrical porous body 710, the first flange 724 having an outer diameter 728 that is greater than the outer diameter 714 of the first hollow cylindrical porous body 710 and a circular aperture 730 in the center of the flange 724 that defines an inner diameter 732 of the flange 724 that is substantially the same as the inner diameter 718 of the first hollow cylindrical porous body 710. The first flange 724 is aligned axially with the first hollow cylindrical porous body 710 such that the circular aperture 730 provides an inlet 734 to the central void space 720.

The filtration device 700 has a second flange 736 adjacent to a second end 738 of the first hollow cylindrical porous body 710 and aligned substantially axially with the first hollow cylindrical porous body 710. The second flange 736 has an outer diameter 740 greater than the outer diameter 714 of the first hollow cylindrical porous body 710. The second flange 736 has a circular aperture 742 in the center of the flange 736 that defines an inner diameter 744 of the second flange 736 that is substantially the same as the inner diameter 718 of the first hollow cylindrical porous body 710.

The filtration device 700 has a second hollow cylindrical porous body 746 having a first end 748 adjacent to the second flange 736 and on the opposite side of the second flange 736 from the first hollow cylindrical porous body 710. The second hollow cylindrical porous body 746 is aligned substantially axially with the second flange 736. The second hollow cylindrical porous body 746 has an outer surface 750 defining an outer diameter 752 and an inner surface 754 defining an inner diameter 756 and a central void space 758. A cylindrical plug 760 having an outer diameter 762 substantially the same as the inner diameter 744 of the second flange 736 extends from within the central void space 720 of the first hollow cylindrical porous body 710 through the circular aperture 742 of the second flange 736 and into the void space 758 of the second hollow cylindrical porous body 746 such that the central void space 720 of the first hollow cylindrical porous body 710 is not in communication with the central void space 758 of the second hollow cylindrical porous body 746. The outer diameter 752 is smaller than the outer diameter 740 of the second flange 736. The outer diameter 752 of the second hollow cylindrical porous body 746 may be, but is not necessarily, substantially the same as the outer diameter 714 of the first hollow cylindrical porous body 710. The second hollow cylindrical porous body 746 has a second plurality of pores 764 extending from the outer surface 750 to the inner surface 754 and configured to allow a fluid to flow between the central void space 758 and the outer surface 750.

The filtration device 700 has a third flange 766 adjacent to the second end 768 of the second hollow cylindrical porous body 746, the third flange 766 having an outer diameter 770 that is substantially the same as the outer diameter 728 of the first flange and a circular aperture 772 in the center of the third flange 766 that defines an inner diameter 774 of the third flange 766 that is substantially the same as the inner diameter 756 of the second hollow cylindrical porous body 746. The third flange 766 is aligned axially with the second hollow cylindrical porous body 746 such that the circular aperture 772 provides an outlet 776 from the central void space 758.

In some embodiments, the filtration device 700 may be used in conjunction with a housing such as a canister, casing, or tube. In some embodiments, the first and second hollow, cylindrical, porous bodies of filtration device 700 are wrapped with a fabric, thread, yarn, fiber or other substrate that is associated with a filtration media. As described above, the filtration media may be coated onto, impregnated into, or otherwise incorporated into the substrate. The filtration media may be any media or combination of media described herein and in some embodiments includes at least one graphene powder. In some embodiments, the substrate is wrapped around the first and second hollow cylindrical porous bodies to a thickness substantially the same as the diameter of the second flange.

In some embodiments a fabric having filtration media incorporated therein is wrapped around the hollow, cylindrical, porous bodies of a filtration device 700 as shown in FIGS. 7A-7D. In one embodiment, a fluid to be filtered flows through the inlet 734, into the central void space 720 of the first hollow cylindrical porous body 710, and from the central void space 720 radially outward through the first plurality of pores 722 to the outer surface 712. The fluid then flows substantially radially outward through the fabric containing the filtration media. At the outer surface 712 of the substrate, the fluid flows past the second flange 736 toward the second hollow cylindrical porous body 746, which is also wrapped in a fabric containing filtration media. The fluid flows substantially radially inward through the fabric toward the outer surface 750 of the second hollow cylindrical porous body 746, then radially inward through the second plurality of pores 764 to the central void space 758. Finally, the fluid flows out of the central void space 758 through the outlet 776.

The filtration device shown in FIGS. 7A-7D and described above is a two stage device, i.e., a fluid passing through the device is filtered twice, once when it passes through the media associated with the first hollow cylindrical porous body and again when it passes through the media associated with the second hollow cylindrical porous body. It should be understood that the apparatus shown in FIGS. 7A-7D is simply one example of one embodiment and that other embodiments, such as single stage devices and multi-stage devices, are also contemplated by the current disclosure.

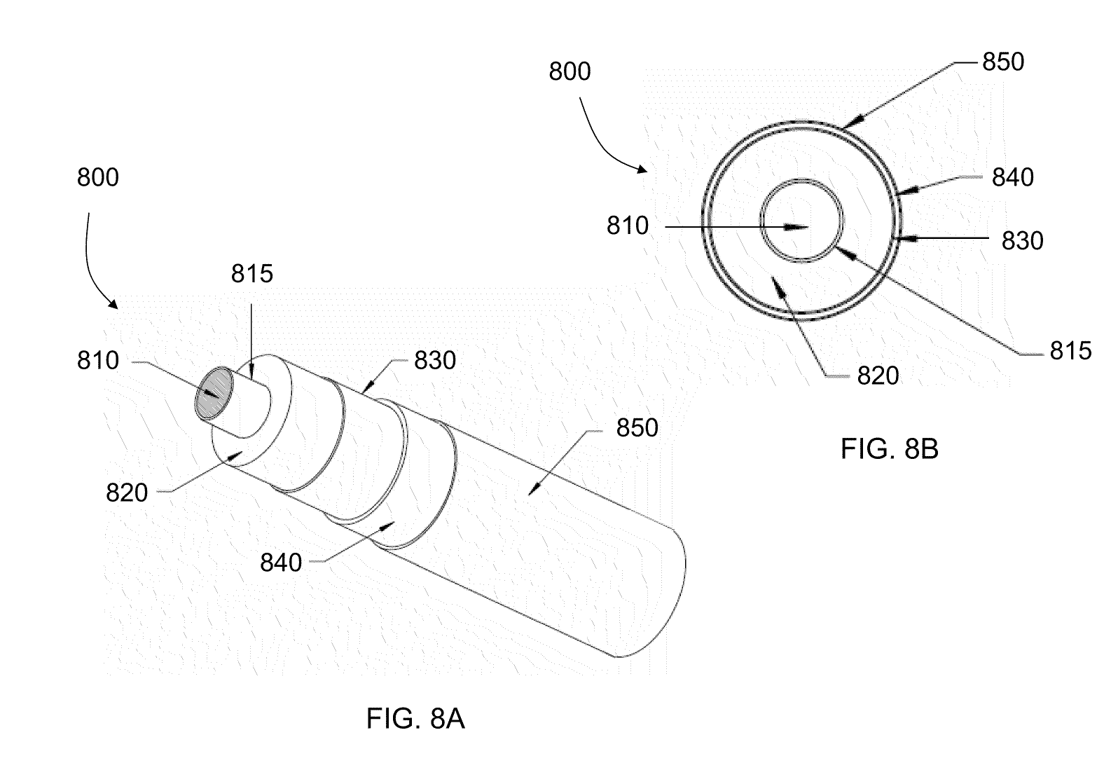

In another embodiment shown in FIGS. 8A and 8B, the filtration media described herein can be incorporated into an in-line radial flow filtration cartridge 800. The cartridge includes a hollow inner core 810 surrounded by an inner mesh tube 815. Graphene filtration media 820 according to embodiments described herein surrounds the mesh tube 815. A mid-mesh tube 830 surrounds the media 820. A layer of spun-bonded polypropylene 840 surrounds the mid-mesh tube 830. The outer layer of the cartridge 800 is an outer mesh tube 850.

The inner mesh tube 815, mid-mesh tube 830 and outer mesh tube 840 are formed from polypropylene, and have from 30-100 pores per lineal inch (“PPI”).

During operation, the contaminated fluid is introduced into the cartridge 800 through the outer mesh tube 850, and then, in order, the spun-bonded polypropylene 840, mid-mesh tube 830, filtration media 820 and inner mesh tube 815. The filtered fluid then enters the hollow inner core 810 and exits the cartridge 800. The various layers of mesh and spun bonded polypropylene mechanically remove particulate contaminants from the fluid and the graphene-based filtration media 820 chemically and mechanically remove contaminants from the fluid.

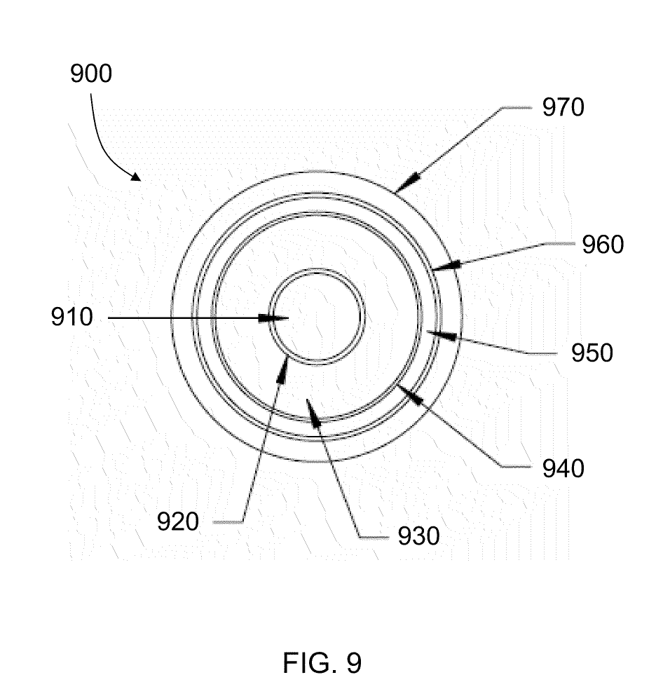

The an embodiment shown in FIG. 9, an in-line radial flow filtration cartridge 900 includes a hollow inner core 910, an inner mesh tube 920, filtration media 930 according to embodiments described herein, a mid-mesh tube 940, a spun-bond polypropylene tube 950, and an outer mesh tube 960. An outer casing 970 envelops and protects the cartridge 900.

Operation of the cartridge of FIG. 9 is similar to that described above for the embodiment of FIGS. 8A and 8B, with contaminated fluid introduced through the outer mesh tube 960, and then, in order, the spun-bonded polypropylene 950, mid-mesh tube 940, filtration media 930 and inner mesh tube 920. The filtered fluid then enters the hollow inner core 910 and exits the cartridge 900.

The filtration devices described herein may be used in conjunction with other filtration devices such as pre-filters in a filtration system. Pre-filters can help to extend the life of the filtration devices described herein.

In some embodiments, the media of the present invention have unique performance characteristics including the ability to reduce arsenic in fluids, reduce turbidity in water, and reduce chlorine and VOC's in fluids. For example, aqueous influent containing at least arsenic III and arsenic V at amounts of up to 50 mg/L was prefiltered with a 0.45 micron sediment filter. Using a graphene-based filtration media consistent with the present invention, the levels of arsenic III and V were reduced to less than 0.1 micron with proper flow restrictions and other ambient conditions.

These media, in some embodiments, can also purify contaminated water to safe levels for drinking by humans and can reduce contaminants and/or other elements, compounds, and species in air to safe levels for breathing. The media can remove and kill bacterium such as e-coli, cholera, and methylobacterium. The media can also provide reduction of tar in cigarette smoke with minimal effect on nicotine.

Several embodiments of the present invention are described in the following examples, which are not intended to limit the scope of the disclosure contained herein:

### Example 1

Contaminated drinking water containing 25 μg/L arsenic was filtered through a 2.5″×10″ axial flow cartridge (model SL-10) containing a graphene filtration media containing 20% by weight Graphene-Fe, 20% by weight Graphene-Ag, 20% by weight Graphene-Mn and 40% by weight GAC foam substrate (20 PPI). The contaminated water was passed through the filter at 10 mL/min at a pressure of 40 PSI. A control filter having no graphene filtration media was subjected to the same conditions for comparison. Results are provided in Table 1:

TABLE 1

| Filter | Contaminant | Result |
|---|---|---|
| Control | Arsenic | 25 μg/L |
| Graphene | Arsenic | 2 μg/L |

A substantial reduction in arsenic concentration in the effluent fluid was observed when the graphene filtration media was used.

### Example 2

A bacteria test was conducted with an influent containing high density E. coli colonies in excess of 2419 CFU/100 ml. A 42 mm×110 mm axial gravity flow filter having a graphene filtration media containing 50% by weight Graphene-P, 40% by weight Graphene-Ag and 10% by weight Graphene-I mixed with a reticulated foam and GAC substrate was used. Flow through the filter was 15 ml/min. A control filter having no graphene filtration media was subjected to the same conditions for comparison. Results are provided in Table 2:

TABLE 2

| Filter | Contaminant | Result | |
|---|---|---|---|
| Control | E. coli | >2419 | CFU/100 ml |
| Graphene | E. coli | 0 | CFU/100 ml |

A substantial reduction of E. coli colonies in the effluent fluid was observed when the graphene filtration media was used.

### Example 3

A bacteria test was conducted with an influent containing E. coli colonies. A 42 mm×110 mm axial gravity flow filter having a graphene filtration media containing 50% by weight Graphene-P, 40% by weight Graphene-Ag and 10% by weight Graphene-I mixed with a fibrillated polypropylene fiber substrate was used. Flow through the filter was 15 ml/min. A control filter having no graphene filtration media was subjected to the same conditions for comparison. Results are provided in Table 3:

TABLE 3

| Filter | Contaminant | Result | |
|---|---|---|---|
| Control | E. coli | 1732 | CFU/100 ml |
| Graphene | E. coli | 0 | CFU/100 ml |

A substantial reduction of E. coli colonies in the effluent fluid was observed when the graphene filtration media was used.

### Example 4

Several bacteria tests were conducted with an influent containing E. coli colonies. An axial flow gravity filter (Lumbar model PG 410 BA) having a graphene filtration media containing 50% by weight Graphene-P, 40% by weight Graphene-Ag and 10% by weight Graphene-I mixed with a fibrillated polypropylene fiber substrate was used. Flow through the filter was 15 ml/min. A control filter having no graphene filtration media was subjected to the same conditions for comparison. Results are provided in Table 4:

TABLE 4

| Filter | Contaminant | Result | |
|---|---|---|---|
| Control | E. coli | >2214 | CFU/100 ml |
| Graphene | E. coli | 0 | CFU/100 ml |
| Graphene | E. coli | 0 | CFU/100 ml |
| Graphene | E. coli | 0 | CFU/100 ml |
| Graphene | E. coli | 0 | CFU/100 ml |
| Graphene | E. coli | 0 | CFU/100 ml |

A substantial reduction of E. coli colonies in the effluent fluids was observed when the graphene filtration media was used.

### Example 5

Tests were conducted with an influent containing an arsenic contaminant. A low pressure inline filter (model LP 525As) having a graphene filtration media containing 15% by weight Graphene-P, 40% by weight Graphene-Fe, 25% by weight Graphene-Ag and 20% by weight Graphene-Mn mixed with a fibrillated polypropylene fiber substrate was used. Fluid was passed through the filter at 20 PSI and 50 PSI. A control filter having no graphene filtration media was subjected to the same conditions for comparison. Results are provided in Table 5:

TABLE 5

| Filter | Contaminant | Result |
|---|---|---|
| Control | Arsenic | 26 μg/L |
| Graphene (20 PSI) | Arsenic | 1 μg/L |
| Graphene (50 PSI) | Arsenic | 3 μg/L |

A substantial reduction of arsenic in the effluent fluids was observed when the graphene filtration media was used.

### Example 6

Tests were run on contaminated fluid containing over 150 ppb VOCs using chloroform as the surrogate. A gravity filter having a graphene filtration media containing 50% by weight Graphene-P mixed with 50% by weight fibrillated polypropylene fiber substrate was used. The effluent contained less than 4 ppb VOCs at 50 PSI and in some cases less than 1 ppb VOCs or undetectable VOCs at 20 PSI or less.

Specific embodiments and applications of compositions, devices, and methods for removing unwanted contaminants and/or other elements, compounds, and species from fluids have been disclosed. It should be apparent, however, to those skilled in the art that many more modifications besides those already described are possible without departing from the inventive concepts herein.

What is claimed is:

1. A filtration device comprising a filter housing and a filtration media disposed within the housing, where the filtration media comprises one or more of a modified or unmodified graphene powder.

2. The filtration device of claim 1, wherein the filtration media comprises graphene powder selected from the group consisting of unmodified graphene powder, graphene powder chemically modified with silver, graphene powder chemically modified with iodine, graphene powder chemically modified with manganese, graphene powder chemically modified with iron, graphene powder chemically modified with platinum, graphene powder chemically modified with gold and combinations thereof.

3. The filtration device of claim 1, wherein the filtration media comprises at least two graphene powders selected from the group consisting of unmodified graphene powder, graphene powder chemically modified with silver, graphene powder chemically modified with iodine, graphene powder chemically modified with manganese, graphene powder chemically modified with iron, graphene powder chemically modified with platinum, graphene powder chemically modified with gold and combinations thereof.

4. The filtration device of claim 1 wherein the filtration media further comprises at least one of granular activated carbon, titanium oxide, or diatomaceous earth.

5. The filtration device of claim 1 wherein the filtration media comprises at least about 15% by weight unmodified graphene powder, up to about 80% by weight graphene powder modified with silver, and up to about 80% by weight graphene powder modified with iodine.

6. The filtration device of claim 5 wherein the at least about 15% by weight unmodified graphene powder, up to about 80% by weight graphene powder modified with silver, and up to about 80% by weight graphene powder modified with iodine comprises an arsenic sorbent, and wherein the filtration media comprises up to about 95% by weight arsenic sorbent.

7. The filtration device of claim 1 wherein the filtration media further comprises at least about 20% by weight graphene powder modified with silver, up to about 80% by weight unmodified graphene powder, and up to about 80% by weight graphene powder modified with iodine.

8. The filtration device of claim 7 wherein the at least about 20% by weight graphene powder modified with silver, up to about 80% by weight unmodified graphene powder, and up to about 80% by weight graphene powder modified with iodine comprises an arsenic sorbent, and wherein the filtration media comprises up to about 95% by weight arsenic sorbent.

9. The filtration device of claim 1, wherein an inside wall of the housing comprises raised ridges or abrasions.

10. The filtration device of claim 9, wherein the inside wall of the housing comprises between about 1 and about 500 ridges for every one inch of the device.

11. The filtration device of claim 1, wherein the filtration media further comprises at least one additional filtration component selected from the group consisting of an arsenic sorbent, granular activated carbon, titanium oxide, and diatomaceous earth.

12. The filtration device of claim 11, wherein the filtration media is a homogeneous blend.

13. The filtration device of claim 1, wherein the one or more of a modified or unmodified graphene powder are located in discrete, predetermined locations within the housing.

14. The filtration device of claim 1, further comprising a composition disposed within the housing, wherein the composition comprises a substrate and a second filtration media,
wherein the substrate is selected from the group consisting of natural and synthetic polymers, metals and metal alloys, textile fibers, glasses, ceramic materials, sol-gels and combinations thereof;
wherein the second filtration media comprises one or more graphenes selected from the group consisting of unmodified graphenes, graphenes chemically modified with silver, graphenes chemically modified with iodine, graphenes chemically modified with manganese, graphenes chemically modified with iron, graphenes chemically modified with platinum and graphenes chemically modified with gold; and
wherein the second filtration media is associated with the substrate by adsorption, absorption, impregnation, or as a coating.

15. A filtration device comprising a hollow porous body surrounded by a composition comprising a substrate and a filtration media,
wherein the substrate is a yarn, thread, fiber, or woven or non-woven fabric;
wherein the filtration media comprises one or more graphenes selected from the group consisting of unmodified graphenes, graphenes chemically modified with silver, graphenes chemically modified with iodine, graphenes chemically modified with manganese, graphenes chemically modified with iron, graphenes chemically modified with platinum and graphenes chemically modified with gold; and
wherein the filtration media is associated with the substrate by adsorption, absorption, impregnation, or as a coating.

16. The filtration device of claim 15, wherein the filtration media is a homogeneous blend.

17. The filtration device of claim 15, wherein the device is configured for axial fluid flow.

18. The filtration device of claim 15, wherein the device is configured for radial fluid flow.

19. The filtration device of claim 15, wherein the device is a multi-stage device.

20. A composition comprising a substrate and a filtration media,
wherein the substrate is selected from the group consisting of natural and synthetic polymers, metals and metal alloys, textile fibers, glasses, ceramic materials, sol-gels, and combinations thereof;
wherein the filtration media comprises one or more graphenes selected from the group consisting of unmodified graphenes, graphenes chemically modified with silver, graphenes chemically modified with iodine, graphenes chemically modified with manganese, graphenes chemically modified with iron, graphenes chemically modified with platinum and graphenes chemically modified with gold; and
wherein the filtration media is associated with the substrate by adsorption, absorption, impregnation, or as a coating.

21. The composition of claim 20, wherein the substrate is in the form of a yarn, thread, fiber, woven fabric, non-woven fabric or combination thereof.

22. The composition of claim 21, wherein the yarn, thread, fiber, woven fabric, non-woven fabric or combination thereof comprises polypropylene, polyethylene, nylon or combinations thereof.

23. The composition of claim 22, wherein the non-woven fabric is spun-bonded polypropylene.

24. The composition of claim 20, wherein the substrate is in the form of a polymeric foam.

25. The composition of claim 24, wherein the polymeric foam is a polypropylene foam.

26. The composition of claim 20, wherein the substrate is in the form of a metal foam.

27. The composition of claim 26, wherein the metal foam comprises a brass-based alloy, a titanium-based alloy, or a steel-based alloy.

28. The composition of claim 20, wherein the substrate is present in an amount of between about 0.1% and about 80% by weight of the composition.

29. A method of removing a contaminant from a fluid comprising:
(a) contacting the contaminant with a filtration media,
wherein the filtration media comprises at least one graphene selected from the group consisting of unmodified graphenes, graphenes chemically modified with silver, graphenes chemically modified with iodine, graphenes chemically modified with manganese, graphenes chemically modified with iron, graphenes chemically modified with platinum and graphenes chemically modified with gold, and
wherein contacting the contaminant with the filtration media comprises injecting the media into the fluid, admixing the filtration media with the fluid, or passing the fluid though a filtration device comprising the filtration media; and
(b) removing the filtration media from the fluid.
